(19) United States
(12) Patent Application Publication
(10) Pub. No.: US 2013/0036103 A1
(43) Pub. Date: Feb. 7, 2013

(54) Software Part Validation Using Hash Values

(71) Applicants: Jack D. Lawson, Newcastle, WA (US); Todd William Gould, Marysville, WA (US); Charles David Royalty, Bellevue, WA (US)

(72) Inventors: Jack D. Lawson, Newcastle, WA (US); Todd William Gould, Marysville, WA (US); Charles David Royalty, Bellevue, WA (US)

(73) Assignee: THE BOEING COMPANY, Chicago, IL (US)

(21) Appl. No.: 13/198,467

(22) Filed: Aug. 4, 2011

(51) Int. Cl. G06F 7/00; G06F 17/30

(52) U.S. Cl. 707/698; 707/E17.001

(57) ABSTRACT

A system and method for validating software parts on an aircraft. A first hash value is calculated for a software part on the aircraft. A determination is made on the aircraft as to whether the first hash value matches a second hash value from a software integrity data structure stored on the aircraft. The software integrity data structure comprises the hash values that are not determined on the aircraft for the software parts used by the aircraft. A validation status is provided based on whether the first hash value matches the second hash value. An operation is performed on the software part on the aircraft only if the first hash value matches the second hash value.

### BACKGROUND INFORMATION

1. Field

The present disclosure relates generally to aircraft and, in particular, to managing aircraft software parts. Still more particularly, the present disclosure relates to a method and apparatus for managing aircraft software parts and for validating software parts on an aircraft before operations are performed on the software parts.

2. Background

Modern aircraft are extremely complex. For example, an aircraft may have many types of electronic systems on board. An electronic system on an aircraft may be a line-replaceable unit (LRU). A line-replaceable unit is designed to be easily replaceable. A line-replaceable unit may be replaced when the aircraft is in flight or while the aircraft is on the ground. Line-replaceable units are typically packaged in a box and may be sealed.

An electronic system may take on various forms. An electronic system on an aircraft may be, for example, without limitation, a flight management system, an autopilot, an in-flight entertainment system, a communications system, a navigation system, a flight controller, a flight recorder, and a collision avoidance system. The various electronic systems on an aircraft may communicate with each other via digital airplane networks.

Electronic systems may use software or programming to provide the logic or control for various operations and functions. The software used in these electronic systems is commonly treated as parts in the airline industry. In particular, a software application for use in a line-replaceable unit on an aircraft may be tracked separately from the line-replaceable unit itself. Aircraft software that is treated as an aircraft part may be referred to as a loadable software aircraft part, an aircraft software part, or simply as a software part. Software parts may be considered part of an aircraft's configuration rather than part of the hardware which operates the software.

Aircraft operators are entities that operate aircraft. Aircraft operators also may be responsible for the maintenance and repair of aircraft. Examples of aircraft operators include airlines and military units. When an aircraft operator receives an aircraft, software parts are typically already installed in the electronic systems on the aircraft. An aircraft operator may also receive copies of these loaded software parts in case the parts need to be reinstalled or reloaded into the electronic systems on the aircraft.

Reloading of software parts may be required, for example, if a line-replaceable unit in which the software is used is replaced or repaired. Further, the aircraft operator also may receive updates to the software parts from time to time. These updates may include additional features not present in the currently-installed software parts and may be considered upgrades to one or more electronic systems. Specified procedures may be followed during loading of software parts on an aircraft so that the current configuration of the aircraft, including all of the software parts loaded on the aircraft, is known.

Various operations may be performed on a software part after the part is loaded on the aircraft. For example, the software part may be loaded onto an electronic system, the software part may be run on the electronic system to perform a function, the software part may be deleted, and/or some other operation may be performed on or using the software part. The software part may be validated before any electronic system operations are performed on the part. Validation of the software part may be performed to verify that the software part has not been altered from its original form. Current methods for validating software parts are based on digital signatures and require the use of complicated public key infrastructure components. These processes may be more time consuming and expensive than desired. These processes also have particular limitations in their ability to detect all software part alterations, particularly alterations that are intentional and malicious in nature.

Accordingly, it would be advantageous to have a method and apparatus for validating software parts that are less expensive and improve the detection of altered software so that its use can be prevented.

### SUMMARY

An advantageous embodiment of the present disclosure provides a method for validating software parts on an aircraft. A first hash value is calculated on the aircraft for a software part on the aircraft. Next, it is determined on the aircraft whether the first hash value matches a second hash value from a software integrity data structure stored on the aircraft. The software integrity data structure comprises hash values that are not determined on the aircraft for software parts used by the aircraft. A validation status is provided based on whether the first hash value matches the second hash value. An operation is performed on the software part on the aircraft only if the first hash value matches the second hash value.

Another advantageous embodiment of the present disclosure provides an apparatus which comprises a software integrity data structure stored on the aircraft, a calculator on the aircraft, and a comparator on the aircraft. The software integrity data structure comprises hash values that are not determined on the aircraft for software parts used by the aircraft. The calculator is configured to calculate a first hash value for a software part on the aircraft. The comparator is configured to determine whether the first hash value matches a second hash value from the software integrity data structure. The aircraft is configured to perform an operation on the software part only if the first hash value matches the second hash value.

Another advantageous embodiment of the present disclosure provides another method for validating software parts for an aircraft. A number of software parts is received. A hash value for each of the number of software parts is determined to form a number of hash values. The number of hash values is combined into a software integrity data structure for use in determining whether to perform operations on a number of software parts on an aircraft.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the advantageous embodiments are set forth in the appended claims. The advantageous embodiments, however, as well as a preferred mode of use, further objectives, and advantages thereof, will best be understood by reference to the following detailed description of an advantageous embodiment of the present disclosure when read in conjunction with the accompanying drawings, wherein:

FIG. 1 is a block diagram of a software part management environment for managing software parts on the ground and on an aircraft in accordance with an advantageous embodiment;

FIG. 2 is a block diagram of a system for determining whether software parts on an aircraft are correct in accordance with an advantageous embodiment;

FIG. 3 is a block diagram of a software integrity data structure in accordance with an advantageous embodiment;

FIG. 4 is a block diagram showing a flow of software parts from a software supplier to an aircraft and a flow of information for validation of the software parts for use on the aircraft in accordance with an advantageous embodiment;

FIG. 5 is a block diagram showing another flow of information for validation of software parts on an aircraft in accordance with an advantageous embodiment;

FIG. 6 is a block diagram showing another flow of information for validation of software parts on an aircraft in accordance with an advantageous embodiment;

FIG. 7 is a block diagram showing a flow of software parts from an aircraft operator to an aircraft in accordance with an advantageous embodiment;

FIG. 8 is a flowchart of a process for generating and using a software integrity data structure in accordance with an advantageous embodiment;

FIG. 9 is a flowchart of a process for validating a software part on an aircraft in accordance with an advantageous embodiment; and

FIG. 10 is an illustration of a data processing system in accordance with an advantageous embodiment.

### DETAILED DESCRIPTION

The different advantageous embodiments recognize and take into account a number of different considerations. “A number”, as used herein with reference to items, means one or more items. For example, “a number of different considerations” are one or more different considerations.

The different advantageous embodiments recognize and take into account that current methods for validating software and other data loaded on an aircraft are based on physical media handling processes and/or digital signatures. Physical media handling processes for aircraft software parts may include the use of secure shipping methods, electronic inspection of media content, and cyclic redundancy check verification of software parts by equipment onboard the aircraft.

The different advantageous embodiments also recognize and take into account that digital signatures using certificate-based public key infrastructures (PKI) are currently used to provide validation for software parts loaded on aircraft. Use of digital signatures relies on public key infrastructure components that require expensive setup and maintenance. Furthermore, public key infrastructure-based security solutions are not well suited to use on fleets of mobile aircraft due to the difficulty of maintaining keys and certificates in aircraft applications. For example, the different advantageous embodiments recognize and take into account that certificate-based public key infrastructure solutions require a certificate with a limited lifetime and timely revocation status. Aircraft with limited connectivity to ground-based certificate authorities may not be able to determine certificate registration status in a timely manner.

Advantageous embodiments also recognize and take into account that currently, aircraft may employ commercial off-the-shelf public key infrastructure software that may not be evaluated for safety in aircraft applications. Therefore, safety certification of aircraft systems employing such software can be complicated.

Advantageous embodiments provide an improvement in the methods by which software is validated for use on aircraft electronic systems. In particular, advantageous embodiments provide an improvement in the way that the integrity of software parts on an aircraft is validated.

In accordance with an advantageous embodiment, hash values and digital fingerprints are generated for software parts to be loaded on an aircraft. The hash values and fingerprints may be stored in a software integrity data structure. The software integrity data structure is loaded onto the aircraft separately from the other software parts. The software integrity data structure is validated and secured before it is used to validate other software parts. The software integrity data structure may be validated and secured using methods known in the industry, such as, without limitation, secure networks, secure storage, PKI, or validation of a hash of the software integrity data structure against a known good value. The hash values and fingerprints may then be used to validate the software parts on the aircraft before operations are performed on the software parts in the aircraft electronic systems. In one embodiment, a software part may be validated by an electronic system of the aircraft which will operate the software. In another advantageous embodiment, the software part may be validated by a software validator before the software part is transferred to a line-replaceable unit.

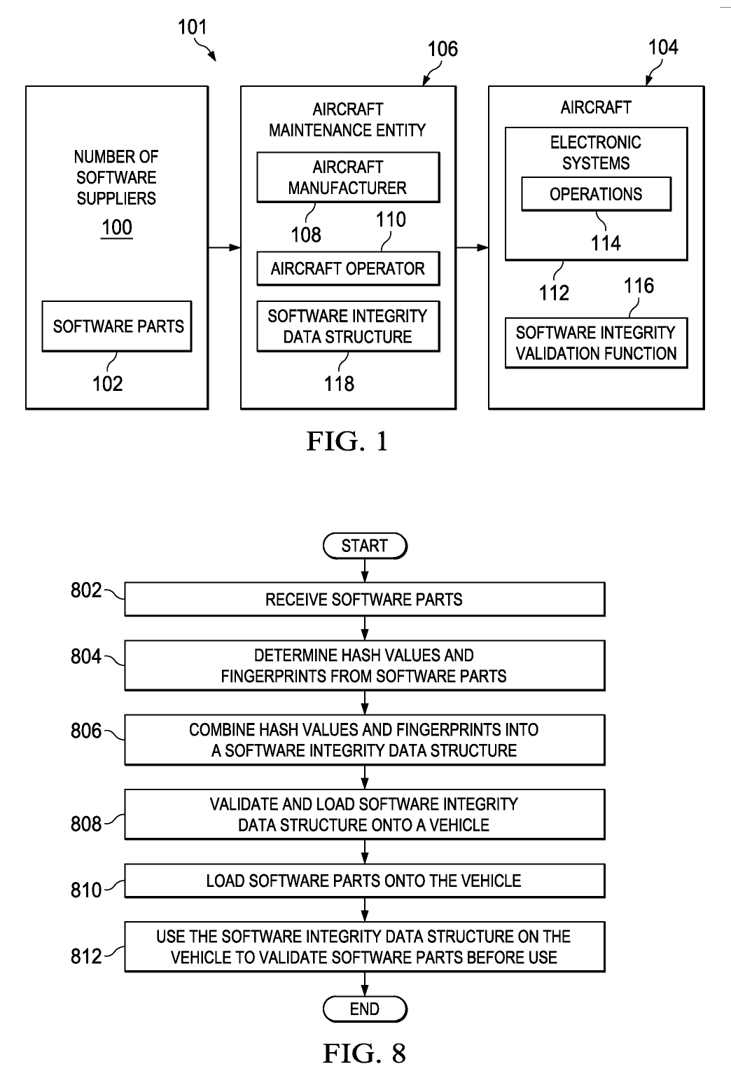

Turning now to FIG. 1, a block diagram of a software part management environment for managing software parts on the ground and on an aircraft is depicted in accordance with an advantageous embodiment. In this example, number of software suppliers 100 in software part management environment 101 supply software parts 102. Number of software suppliers 100 may include any entity that develops or otherwise supplies software parts 102. For example, without limitation, number of software suppliers 100 may include an aircraft manufacturer; an aircraft operator, such as an airline or military organization; or a third party software developer. Software parts 102 may comprise any software applications or data to be used on aircraft 104.

Aircraft maintenance entity 106 in software part management environment 101 loads software parts 102 provided by number of software suppliers 100 on aircraft 104 for use on aircraft 104. Aircraft maintenance entity 106 may be any entity that is responsible for loading software parts 102 on aircraft 104. For example, aircraft maintenance entity 106 may include aircraft manufacturer 108 or aircraft operator 110. Aircraft operator 110 may be, without limitation, an airline, military organization, or any other private or government organization that operates aircraft 104. Aircraft maintenance entity 106 may or may not be the owner of aircraft 104. Aircraft maintenance entity 106 may include an entity acting on behalf of the owner of aircraft 104 to load software parts 102 on aircraft 104. In any case, it is assumed that aircraft maintenance entity 106 has authority to load software parts 102 on aircraft 104. Aircraft maintenance entity 106 may follow specified procedures for loading of software parts 102 on aircraft 104 so that the current configuration of aircraft 104, including all software parts 102 currently loaded on aircraft 104, is known.

Aircraft 104 may be a commercial or private passenger or cargo aircraft or a military or other government aircraft. Software parts 102 may be distributed to aircraft 104 by aircraft maintenance entity 106. For example, software parts 102 may be loaded onto aircraft 104 for use by electronic systems 112 on aircraft 104. For example, electronic systems 112 may include line-replaceable units.

Operations 114 performed on or using software parts 102 by electronic systems 112 may affect the performance or safety of aircraft 104. Therefore, it is desirable to determine whether software parts 102 on aircraft 104 are correct. Determining whether software parts 102 to be used on aircraft 104 are correct and not corrupted may be referred to as validating software parts 102. Operations 114 should not be performed by electronic systems 112 on software parts 102 on aircraft 104 if the integrity of software parts 102 cannot be confirmed to be correct.

Validating the integrity of software parts 102 may include determining whether software parts 102 currently loaded on aircraft 104 are the same as software parts 102 that were produced by number of software suppliers 100. Software parts 102 on aircraft 104 may become corrupted or otherwise changed. For example, software parts 102 may be corrupted during the process of software part distribution from number of software suppliers 100 to aircraft maintenance entity 106 to aircraft 104 and during storage of software parts 102 at various locations during this process. Such changes to software parts 102 may be accidental or malicious.

In accordance with an advantageous embodiment, software integrity validation function 116 may be performed on aircraft 104. Software integrity validation function 116 may be used to determine whether software parts 102 on aircraft 104 are correct before operations 114 are performed on software parts 102. Software integrity validation function 116 may be used to validate software parts 102 loaded on aircraft 104 periodically.

In accordance with an advantageous embodiment, software integrity validation function 116 employs hash values and other attributes collected in software integrity data structure 118 to validate software parts 102 on aircraft 104. Software integrity data structure 118 also may be referred to as a hash file or a master hash file. Software integrity data structure 118 may be generated by aircraft maintenance entity 106 and may be loaded on aircraft 104 by aircraft maintenance entity 106. Aircraft maintenance entity 106, which generates software integrity data structure 118, may be the same as or different from aircraft maintenance entity 106, which loads software parts 102 on aircraft 104.

Over time, certain software parts 102 may be removed from aircraft 104, and new software parts 102 may be loaded on aircraft 104. These actions change the configuration of aircraft 104. New software parts 102 loaded on aircraft 104 will require changes to software integrity data structure 118, which is used to validate software parts 102 on aircraft 104. Changes to software integrity data structure 118 may be made by generating an entirely new software integrity data structure 118 reflecting all existing software parts for the model of aircraft 104.

Alternatively, necessary changes to software integrity data structure 118 to reflect new software parts may be provided as updates to existing software integrity data structure 118. Updates to software integrity data structure 118 may be generated by aircraft maintenance entity 106. Updates to software integrity data structure 118 may be loaded onto aircraft 104 to update software integrity data structure 118 on aircraft 104 without requiring regeneration and reloading of the entire software integrity data structure 118.

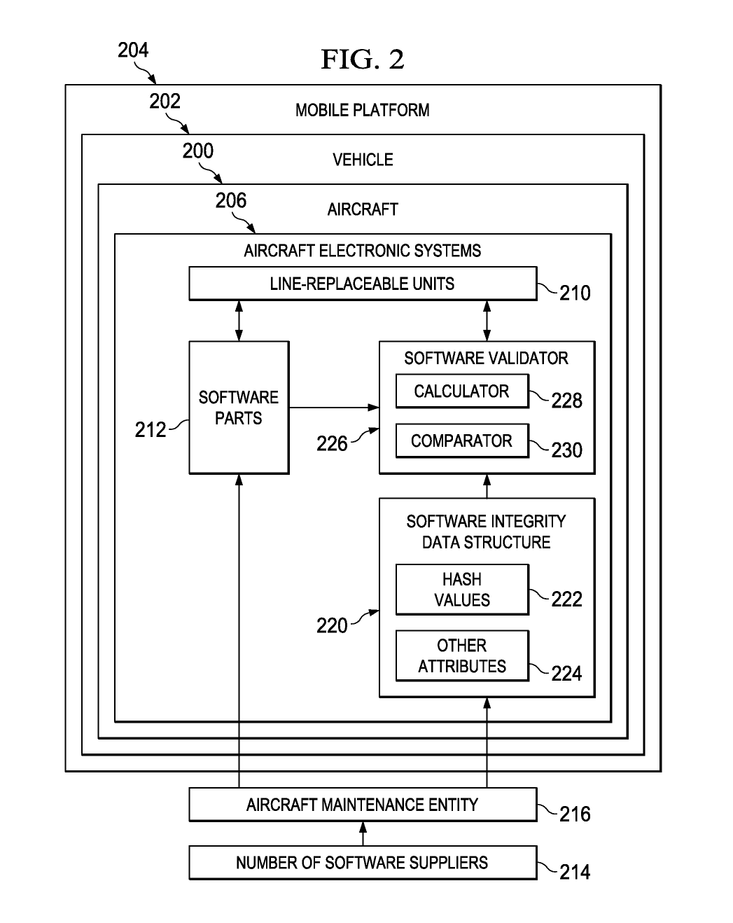

Turning now to FIG. 2, a block diagram of a system for determining whether software parts on an aircraft are correct is depicted in accordance with an advantageous embodiment. In this example, aircraft 200 is an example of one implementation of aircraft 104 in FIG. 1. Aircraft 200 is an example of vehicle 202 in which advantageous embodiments may be implemented. Vehicle 202 may be another type of aerospace vehicle, such as a spacecraft or any other vehicle that is capable of travelling through the air, in space, or both. Vehicle 202 may also be a ground vehicle or a water vehicle, such as a train, a surface ship, or a submarine. Vehicle 202 is an example of one type of mobile platform 204 in which advantageous embodiments may be implemented.

Aircraft 200 may include aircraft electronic systems 206. Aircraft electronic systems 206 may comprise various hardware devices or systems that are connected together in any appropriate network architecture. Aircraft electronic systems 206 may include line-replaceable units 210. For example, without limitation, aircraft electronic systems 206 may include systems with processors that run software in the form of software parts 212.

Software parts 212 may be developed or otherwise provided by number of software suppliers 214. Software parts 212 from number of software suppliers 214 may be loaded onto aircraft 200 by aircraft maintenance entity 216. In this example, number of software suppliers 214 is an example of number of software suppliers 100 in FIG. 1, and aircraft maintenance entity 216 is an example of aircraft maintenance entity 106 in FIG. 1.

Aircraft maintenance entity 216 also may generate and load software integrity data structure 220 on aircraft 200. In accordance with an advantageous embodiment, software integrity data structure 220 is used to validate the other software parts 212 on aircraft 200. Therefore, software integrity data structure 220 may be loaded onto aircraft 200 and maintained in aircraft 200 in a manner that maintains the security of software integrity data structure 220.

For example, software integrity data structure 220 may be loaded onto aircraft 200 in the manner of other aircraft software parts 212 to maintain proper configuration control of aircraft 200. A digital signature or other method or system may be used to provide security for software integrity data structure 220 when loaded on aircraft 200 and to prevent corruption of software integrity data structure 220 on aircraft 200.

Software integrity data structure 220 includes hash values 222 and other attributes 224 for software parts 212 on aircraft 200. Hash values 222 and other attributes 224 are generated by aircraft maintenance entity 216 or some other entity from software parts 212 before software parts 212 are loaded on aircraft 200.

Hash values 222 may include digital or other numeric values that are generated from software parts 212 using any appropriate cryptographic or other appropriate hash function. For example, without limitation, the SHA-256 hash function or another hash function may be used to generate hash values 222 for software parts 212. The SHA-256 hash function results in a 256 bit hash value for any given software part.

Other attributes 224 may include various digital alphanumeric or other values that identify software parts 212. Other attributes 224 may be associated in software integrity data structure 220 with corresponding hash values 222 for corresponding software parts 212. Other attributes 224 may include one or more fingerprints for each of software parts 212. These fingerprints may be generated from software parts 212 using a fingerprinting algorithm or fingerprint function. The algorithm or function used to generate other attributes 224 is preferably different from the hash function used to generate hash values 222.

Hash values 222 and other attributes 224 from software integrity data structure 220 may be used by software validator 226 to validate software parts 212 on aircraft 200. In this example, software validator 226 is an example of an apparatus for performing software integrity validation function 116 of FIG. 1. Software validator 226 may be implemented in aircraft electronic systems 206 using hardware or hardware operating in combination with software to implement the functions of software validator 226 as described herein.

Software validator 226 may include calculator 228 and comparator 230. Calculator 228 is used by software validator 226 to determine hash values for software parts 212 on aircraft 200. The hash values determined by calculator 228 may be referred to as first hash values. The hash values for software parts 212 on aircraft 200 are determined by calculator 228 using the same hash function that was used to generate hash values 222 in software integrity data structure 220. Hash values 222 in software integrity data structure 220 may be referred to as second hash values.

Calculator 228 also may be used by software validator 226 to determine other attributes for software parts 212 on aircraft 200. The other attributes determined by calculator 228 may be referred to as first attributes. The other attributes for software parts 212 on aircraft 200 are determined by calculator 228 using the same algorithm or function that was used to generate other attributes 224 in software integrity data structure 220. Other attributes 224 in software integrity data structure 220 may be referred to as second attributes.

Comparator 230 is used by software validator 226 to compare the hash values generated by calculator 228 with hash values 222 in software integrity data structure 220 for corresponding software parts 212. Comparator 230 also may be used by software validator 226 to compare the other attributes generated by calculator 228 with other attributes 224 in software integrity data structure 220 for corresponding software parts 212.

If the hash value for one of software parts 212 on aircraft 200 as determined by calculator 228 does not match the hash value from software integrity data structure 220 for the software part, then the software part is not validated. Similarly, if the other attributes for one of software parts 212 on aircraft 200 as determined by calculator 228 does not match other attributes 224 from software integrity data structure 220 for the software part, then the software part is not validated. In either case, software validator 226 may provide an indication to aircraft electronic systems 206 that the software part is not validated. In this case, aircraft electronic systems 206 may not perform operations on the software part. An onboard or off-board human operator of aircraft 200 may be informed when software validator 226 determines that a software part is not validated so that the appropriate action may be taken.

If comparator 230 determines that both the hash value for one of software parts 212 on aircraft 200 as determined by calculator 228 matches the hash value from software integrity data structure 220 for the software part and the other attributes for the software part on aircraft 200 as determined by calculator 228 matches other attributes 224 from software integrity data structure 220 for the software part, then the software part is validated. In this case, software validator 226 may provide an indication to aircraft electronic systems 206 that the software part is validated, and aircraft electronic systems 206 may perform desired operations on the validated software part.

Any differences between software parts 212 on aircraft 200 and the software parts used to generate hash values 222 and other attributes 224 will result in calculator 228 determining hash values and other attributes for software parts 212 that are different from hash values 222 and other attributes 224 in software integrity data structure 220. These differences may be the result of software parts 212 being provided or loaded from an unauthorized source or compromised integrity of software parts 212 on aircraft 200.

In any case, comparator 230 will detect these differences so that appropriate actions may be taken. For example, these actions may include, without limitation, not performing operations on such software parts 212 on aircraft 200 and notifying an operator of aircraft 200 that such software parts 212 on aircraft 200 are not correct.

It is possible that the hash function used to generate hash values 222 in software integrity data structure 220 may be diminished over time in its ability to uniquely identify particular bit images of software parts 212. Requiring both hash values and other attributes determined by calculator 228 to match hash values 222 and other attributes 224 in software integrity data structure 220 in order for software parts 212 to be validated provides increased confidence in the validation and extends the useful life of software integrity data structure 220.

The illustrations of FIG. 1 and FIG. 2 are not meant to imply physical or architectural limitations to the manner in which different advantageous embodiments may be implemented. Other components in addition to and/or in place of the ones illustrated may be used. Some components may be unnecessary in some advantageous embodiments. Also, the blocks are presented to illustrate some functional components. One or more of these blocks may be combined and/or divided into different blocks when implemented in different advantageous embodiments.

For example, more than one software validator 226 may be implemented for simultaneous operation in aircraft 200. Furthermore, the functions performed by software validator 226 may be implemented in one or more locations in aircraft 200. In one example, software validator 226 may be implemented in one or more aircraft electronic systems 206 that operate software parts 212. As another example, software validator 226 may be implemented as a separate software integrity validation function used to validate software parts 212 for use on a number of aircraft electronic systems 206. In this case, the functions performed by software validator 226 may be performed to validate software parts 212 before software parts 212 are loaded into aircraft electronic systems 206 or before operations are performed on software parts 212 by aircraft electronic systems 206.

As another example, the functions performed by software validator 226 may be performed at different locations in aircraft electronic systems 206. For example, the functions performed by calculator 228 may be performed by aircraft electronic systems 206 in which software parts 212 to be validated are loaded. In this case, the hash values and other attributes determined by calculator 228 may be sent to comparator 230 located at another location in aircraft 200. Comparator 230 may then send an indication back to aircraft electronic systems 206 indicating the results of the comparisons performed by comparator 230 for software parts 212 loaded in aircraft electronic systems 206.

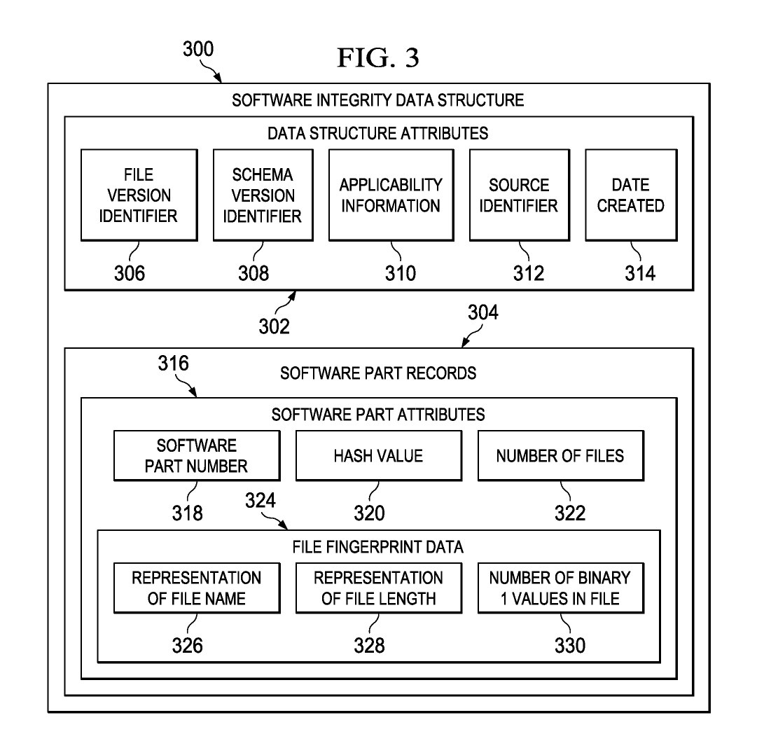

Turning now to FIG. 3, a block diagram of a software integrity data structure is depicted in accordance with an advantageous embodiment. In this example, software integrity data structure 300 is an example of one implementation of software integrity data structure 118 in FIG. 1 and software integrity data structure 220 in FIG. 2. Software integrity data structure 300 may include data structure attributes 302 and number of software part records 304.

Data structure attributes 302 may include attributes that describe software integrity data structure 300 itself. For example, without limitation, data structure attributes 302 may include file version identifier 306, schema version identifier 308, applicability information 310, source identifier 312, and date created 314.

File version identifier 306 may identify a particular version of software integrity data structure 300. Schema version identifier 308 may identify the version of a schema used to create software integrity data structure 300. For example, schema version identifier 308 may identify the version of an XML schema used to create software integrity data structure 300. Applicability information 310 may include information about the aircraft or other vehicle on which software integrity data structure 300 may be used. For example, applicability information 310 may include information identifying an aircraft model or aircraft system on which software integrity data structure 300 may be used.

Source identifier 312 may identify the entity that created software integrity data structure 300. For example, source identifier 312 may include the name of the company or other entity that created software integrity data structure 300. Date created 314 may specify the date that software integrity data structure 300 was created.

Each software part in an aircraft that may be validated using software integrity data structure 300 may be represented by a corresponding one of software part records 304 in software integrity data structure 300. Each one of software part records 304 may include a number of software part attributes 316. Software part attributes 316 may include attributes that describe or are derived from the software parts represented by corresponding software part records 304. For example, without limitation, software part attributes 316 may include software part number 318, hash value 320, number of files 322, and file fingerprint data 324.

Software part number 318 may include a number identifying the software part represented by the corresponding software part record. Hash value 320 may include the hash value determined for the software part. For example, without limitation, hash value 320 may include a hexadecimal or other representation of a hash value obtained from an SHA-256 or other hash function that is computed using the software part as input. Number of files 322 may indicate the number of files that make up the software part.

File fingerprint data 324 may include a fingerprint for the software part that is derived from the software part. File fingerprint data 324 may be provided for each with the number of files in the software part. File fingerprint data 324 may be derived from the software part using one or more fingerprint algorithms or functions used for each software part file. Preferably, file fingerprint data 324 is not determined from the software part using a hash function, such as the hash function used to determine hash value 320. In one example, file fingerprint data 324 may include representation of file name 326, representation of file length 328, and number of binary 1 values in file 330. For example, representation of file name 326 may include an ASCII character representation or other representation of the software part file name.

Representation of file length 328 may comprise an ASCII integer or other representation of the software part file length in bytes. Number of binary 1 values in file 330 may include an ASCII integer or other representation of the number of binary 1 values contained in the software part file.

File fingerprint data 324 may be a string value that is formed by concatenating representation of file name 326, representation of file length 328, and number of binary 1 values in file 330 with each item separated by a semi-colon or other character. A fingerprint, in accordance with an advantageous embodiment, may be determined and formatted differently from file fingerprint data 324 described by example herein. Also, a software integrity data structure, in accordance with an advantageous embodiment, may include more, fewer, or different data structure attributes or software part attributes from those described by example herein.

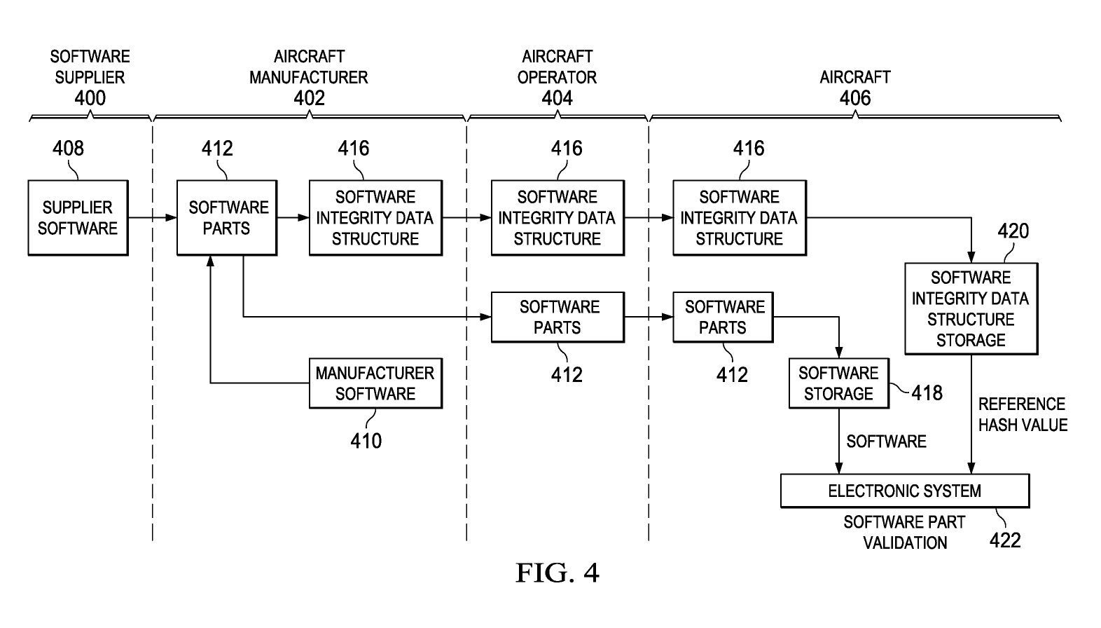

Turning now to FIG. 4, a block diagram showing a flow of software parts from a software supplier to an aircraft and a flow of information for validation of the software parts for use on the aircraft is depicted in accordance with an advantageous embodiment. In this example, software supplier 400 and aircraft manufacturer 402 are examples of number of software suppliers 100 in FIG. 1 and number of software suppliers 214 in FIG. 2. In this example, aircraft operator 404 is an example of aircraft maintenance entity 106 in FIG. 1 and aircraft maintenance entity 216 in FIG. 2. In this example, aircraft 406 is an example of aircraft 104 in FIG. 1 and aircraft 200 in FIG. 2.

Software supplier 400 develops or otherwise provides supplier software 408 to aircraft manufacturer 402. Software supplier 400 may be one of a number of third party or other software suppliers that provide supplier software 408 to aircraft manufacturer 402.

Aircraft manufacturer 402 may develop its own manufacturer software 410. Aircraft manufacturer 402 may combine its own manufacturer software 410 with supplier software 408 from software supplier 400 to provide software parts 412 to aircraft operator 404. Software parts 412 may be loaded by aircraft manufacturer 402 onto an aircraft in production. Aircraft manufacturer 402 also may generate software integrity data structure 416 from software parts 412. Aircraft manufacturer 402 may provide software parts 412 and software integrity data structure 416 to aircraft operator 404. Aircraft operator 404 may load software integrity data structure 416 onto aircraft 406 and may load or reload software parts 412 on aircraft 406 as needed.

Software parts 412 may be stored in software storage 418 on aircraft 406. Software integrity data structure 416 may be stored in software integrity data structure storage 420 on aircraft 406. In this example, validation of a software part is performed by electronic system 422 on aircraft 406. In this case, a software part may be provided from software storage 418 to electronic system 422, and a reference hash value and other attributes may be provided from software integrity data structure storage 420 to electronic system 422. Electronic system 422 may then determine a hash value and other attributes from the software part and compare the determined hash value and other attributes to the reference hash value and other attributes from software integrity data structure 416 to validate the software part in the manner described above. Electronic system 422 may perform operations on the software part if the software part is validated by electronic system 422.

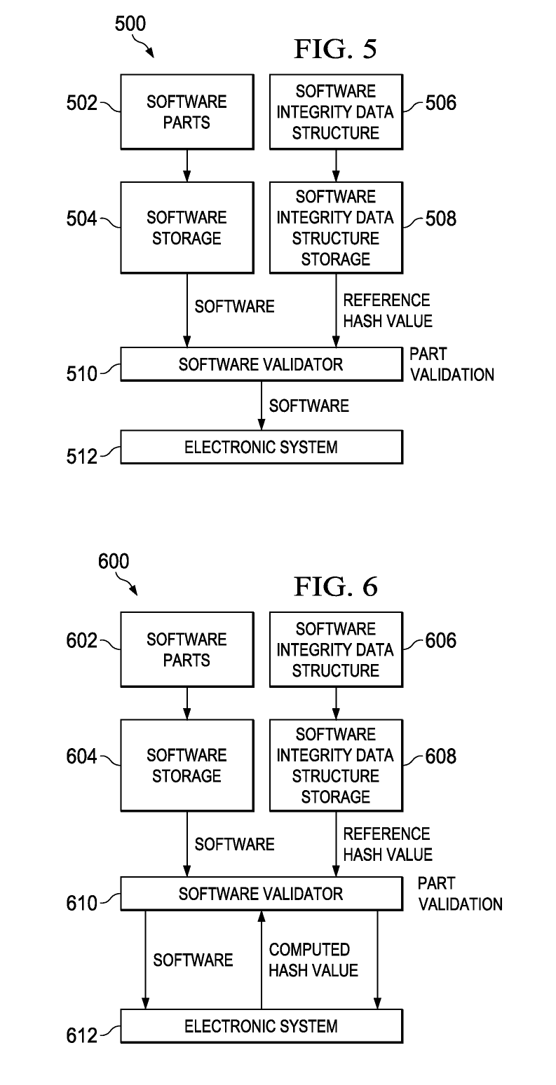

Turning now to FIG. 5, a block diagram showing another flow of information for validation of software parts on an aircraft is depicted in accordance with an advantageous embodiment. In this example, aircraft 500 is another example of aircraft 406 in FIG. 4. FIG. 5 shows a flow of information on aircraft 500 for a process for validating software parts on an aircraft that is an alternative to the process for validating software parts in FIG. 4. Software parts 502 may be stored in software storage 504 on aircraft 500. Software integrity data structure 506 may be stored in software integrity data structure storage 508 on aircraft 500.

In this example, validation of a software part is performed by software validator 510 separate from electronic system 512 on which the software part will be used. In this case, the software part may be sent from software storage 504 to software validator 510, and a reference hash value and other attributes may be sent from software integrity data structure storage 508 to software validator 510. Software validator 510 may then determine a hash value and other attributes from the software part.

Software validator 510 also may compare the determined hash value and other attributes to the reference hash value and other attributes from software integrity data structure 506. This comparison is made to validate the software part in the manner described above. If the software part is validated by software validator 510, the software part may be provided to electronic system 512 on aircraft 500. Operations may then be performed on the validated software part by electronic system 512.

Turning now to FIG. 6, a block diagram showing another flow of information for validation of software parts on an aircraft is depicted in accordance with an advantageous embodiment. In this example, aircraft 600 is another example of aircraft 406 in FIG. 4. FIG. 6 shows a flow of information on aircraft 600 for a process of validating software parts on an aircraft that is an alternative to the processes for validating software parts in FIG. 4 and FIG. 5. Software parts 602 may be stored in software storage 604 on aircraft 600. Software integrity data structure 606 may be stored in software integrity data structure storage 608 on aircraft 600.

In this example, validation of a software part is performed by software validator 610 and electronic system 612. In this case, the software part may be sent from software storage 604 to software validator 610, and a reference hash value and other attributes may be sent from software integrity data structure storage 608 to software validator 610. Software validator 610 may then load the software part onto electronic system 612. Electronic system 612 may determine a hash value and other attributes from the software part.

The hash value and other attributes determined by electronic system 612 may then be sent back to software validator 610. Software validator 610 may then compare the hash value and other attributes determined by electronic system 612 with the hash value and other attributes from software integrity data structure 606 to validate the software part in the manner described above. Software validator 610 may send an indication to electronic system 612 when the software part is validated by software validator 610. Operations may then be performed on the validated software part by electronic system 612.

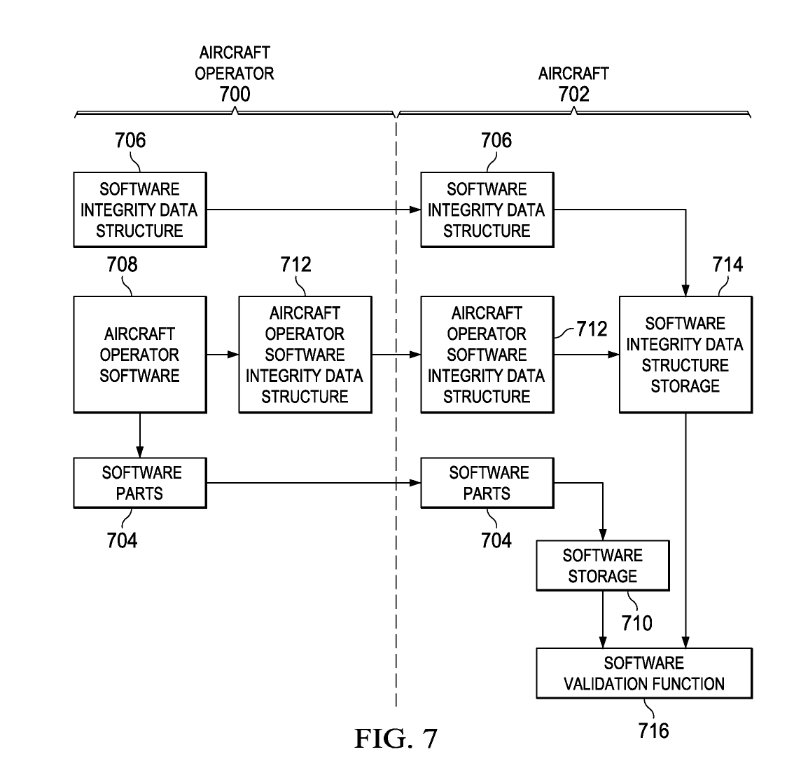

Turning now to FIG. 7, a block diagram showing a flow of software parts from an aircraft operator to an aircraft is depicted in accordance with an advantageous embodiment. In this example, aircraft operator 700 is an example of aircraft operator 404 in FIG. 4, and aircraft 702 is an example of aircraft 406 in FIG. 4.

Aircraft operator 700 is provided software parts 704 and software integrity data structure 706 from an aircraft manufacturer. In this example, aircraft operator 700 may also develop or otherwise provide its own aircraft operator software 708. Aircraft operator 700 may load software parts 704, including aircraft operator software 708, onto aircraft 702. Software parts 704 are stored in software storage 710 on aircraft 702 in this illustrative example.

In this depicted example, aircraft operator 700 also generates its own aircraft operator software integrity data structure 712 from aircraft operator software 708. Software integrity data structure 706 and aircraft operator software integrity data structure 712 may be loaded onto aircraft 702 by aircraft operator 700 and stored in software integrity data structure storage 714 on aircraft 702. Software parts 704 stored in software storage 710 and hash values and other attributes stored in software integrity data structure storage 714 may be used to validate software parts 704 by software validation function 716 on aircraft 702 using one of the procedures for software part validation described above with reference to FIG. 4, FIG. 5, or FIG. 6.

Turning now to FIG. 8, a flowchart of a process for generating and using a software integrity data structure is depicted in accordance with an advantageous embodiment. The process illustrated in FIG. 8 may be implemented, for example, in software part management environment 101 in FIG. 1.

The process begins by receiving software parts (operation 802). For example, operation 802 may include receiving aircraft software parts from a software supplier. Hash values and fingerprints are then determined from the software parts (operation 804). Operation 804 may include determining the hash values and fingerprints from the software parts using appropriate hash functions or other algorithms.

The hash values and fingerprints for multiple software parts may then be combined into a software integrity data structure (operation 806). The software integrity data structure may be validated and loaded onto a vehicle, such as an aircraft (operation 808). It is desirable that the software integrity data structure itself is validated before it is used to validate other software parts. Otherwise, the software integrity data structure cannot be trusted to validate the other software parts.

The software parts also may be loaded onto the vehicle (operation 810). The software integrity data structure may be used on the vehicle to validate the software parts before they are used on the vehicle (operation 812), with the process terminating thereafter.

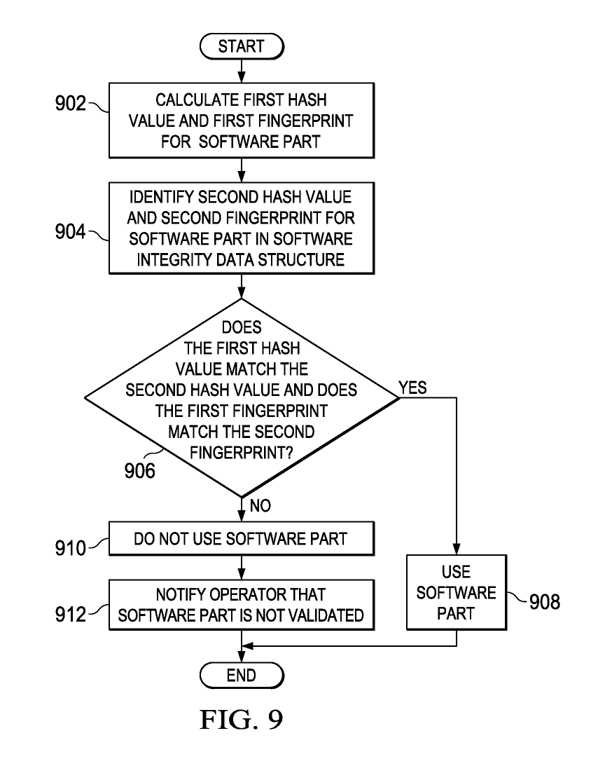

Turning now to FIG. 9, a flowchart of a process for validating a software part on an aircraft is depicted in accordance with an advantageous embodiment. The process of FIG. 9 may be implemented, for example, in software validator 226 in FIG. 2. The process of FIG. 9 is an example of a process that may be used to implement operation 812 in FIG. 8.

The process may begin by calculating a first hash value and a first fingerprint for a software part stored on the aircraft (operation 902). A second hash value and a second fingerprint for the software part are identified in a software integrity data structure (operation 904).

A determination may be made as to whether the first hash value matches the second hash value and the first fingerprint matches the second fingerprint (operation 906). If it is determined that both the hash values and the fingerprints match, the software part may be used on the aircraft (operation 908), with the process terminating thereafter. If a determination is made that either the first hash value does not match the second hash value or the first fingerprint does not match the second fingerprint, then the software part may not be used on the aircraft (operation 910). An operator of the aircraft may be notified if the software part is not validated (operation 912), with the process terminating thereafter.

The flowcharts and block diagrams in the different depicted embodiments illustrate the architecture, functionality, and operation of some possible implementations of apparatuses and methods in an advantageous embodiment. In this regard, each block in the flowcharts or block diagrams may represent a module, segment, function, and/or a portion of an operation or step. For example, one or more of the blocks may be implemented as program code, in hardware, or a combination of program code and hardware. When implemented in hardware, the hardware may, for example, take the form of integrated circuits that are manufactured or configured to perform one or more operations in the flowcharts or block diagrams.

In some alternative implementations of an advantageous embodiment, the function or functions noted in the blocks may occur out of the order shown in the figures. For example, in some cases, two blocks shown in succession may be executed substantially concurrently, or the blocks may sometimes be performed in the reverse order, depending upon the functionality involved. Also, other blocks may be added in addition to the blocks illustrated in a flowchart or block diagram.

One or more of the advantageous embodiments provides a capability to validate the integrity of software or other data distributed from a software supplier to an aircraft. In accordance with an advantageous embodiment, software validation on the aircraft may be performed with or without an aircraft-to-ground network connection. Software validation in accordance with an advantageous embodiment does not require complicated public key infrastructure components, such as certificate authorities. Advantageous embodiments employ hash values for software validation. Hash values do not expire. Therefore, advantageous embodiments eliminate the limitations of certificate management and certificate expiration in systems that rely on public key infrastructure components for software security.

Therefore, advantageous embodiments provide a validation of the integrity of software or other data on an aircraft provided that the source of the software integrity data structure is trusted. Advantageous embodiments also provide for software part validation on an aircraft in a manner that may be safety certified at less risk and cost than current methods using public key infrastructure software.

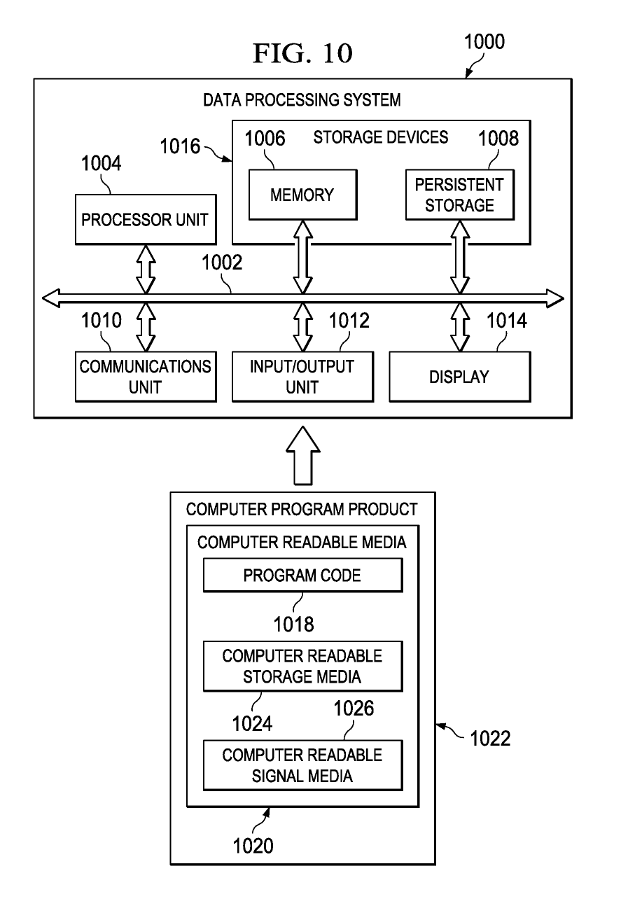

Turning now to FIG. 10, an illustration of a data processing system is depicted in accordance with an advantageous embodiment. In this example, data processing system 1000 is an example of aircraft electronic systems 206 in FIG. 2. For example, data processing system 1000 is an example of one implementation of line-replaceable units 210 in FIG. 2. In this illustrative example, data processing system 1000 includes communications fabric 1002. Communications fabric 1002 provides communications between processor unit 1004, memory 1006, persistent storage 1008, communications unit 1010, input/output (I/O) unit 1012, and display 1014.

Processor unit 1004 serves to execute instructions for software that may be loaded into memory 1006. Processor unit 1004 may be a number of processors, a multi-processor core, or some other type of processor, depending on the particular implementation. A number, as used herein with reference to an item, means one or more items. Further, processor unit 1004 may be implemented using a number of heterogeneous processor systems in which a main processor is present with secondary processors on a single chip. As another illustrative example, processor unit 1004 may be a symmetric multi-processor system containing multiple processors of the same type.

Memory 1006 and persistent storage 1008 are examples of storage devices 1016. A storage device is any piece of hardware that is capable of storing information, such as, for example, without limitation, data, program code in functional form, and/or other suitable information either on a temporary basis and/or a permanent basis. Storage devices 1016 may also be referred to as computer readable storage devices in these examples. Memory 1006, in these examples, may be, for example, a random access memory or any other suitable volatile or non-volatile storage device. Persistent storage 1008 may take various forms, depending on the particular implementation.

For example, persistent storage 1008 may contain one or more components or devices. For example, persistent storage 1008 may be a hard drive, a flash memory, a rewritable optical disk, a rewritable magnetic tape, or some combination of the above. The media used by persistent storage 1008 also may be removable. For example, a removable hard drive may be used for persistent storage 1008.

Communications unit 1010, in these examples, provides for communications with other data processing systems or devices. In these examples, communications unit 1010 is a network interface card. Communications unit 1010 may provide communications through the use of either or both physical and wireless communications links.

Input/output unit 1012 allows for input and output of data with other devices that may be connected to data processing system 1000. For example, input/output unit 1012 may provide a connection for user input through a keyboard, a mouse, and/or some other suitable input device. Further, input/output unit 1012 may send output to a printer. Display 1014 provides a mechanism to display information to a user.

Instructions for the operating system, applications, and/or programs may be located in storage devices 1016, which are in communication with processor unit 1004 through communications fabric 1002. In these illustrative examples, the instructions are in a functional form on persistent storage 1008. These instructions may be loaded into memory 1006 for execution by processor unit 1004. The processes of the different embodiments may be performed by processor unit 1004 using computer-implemented instructions, which may be located in a memory, such as memory 1006.

These instructions are referred to as program instructions, program code, computer usable program code, or computer readable program code that may be read and executed by a processor in processor unit 1004. The program code in the different embodiments may be embodied on different physical or computer readable storage media, such as memory 1006 or persistent storage 1008.

Program code 1018 is located in a functional form on computer readable media 1020 that is selectively removable and may be loaded onto or transferred to data processing system 1000 for execution by processor unit 1004. Program code 1018 and computer readable media 1020 form computer program product 1022 in these examples. In one example, computer readable media 1020 may be computer readable storage media 1024 or computer readable signal media 1026.

Computer readable storage media 1024 may include, for example, an optical or magnetic disk that is inserted or placed into a drive or other device that is part of persistent storage 1008 for transfer onto a storage device, such as a hard drive, that is part of persistent storage 1008. Computer readable storage media 1024 also may take the form of a persistent storage, such as a hard drive, a thumb drive, or a flash memory, that is connected to data processing system 1000. In some instances, computer readable storage media 1024 may not be removable from data processing system 1000.

In these examples, computer readable storage media 1024 is a physical or tangible storage device used to store program code 1018 rather than a medium that propagates or transmits program code 1018. Computer readable storage media 1024 is also referred to as a computer readable tangible storage device or a computer readable physical storage device. In other words, computer readable storage media 1024 is a media that can be touched by a person.

Alternatively, program code 1018 may be transferred to data processing system 1000 using computer readable signal media 1026. Computer readable signal media 1026 may be, for example, a propagated data signal containing program code 1018. For example, computer readable signal media 1026 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some advantageous embodiments, program code 1018 may be downloaded over a network to persistent storage 1008 from another device or data processing system through computer readable signal media 1026 for use within data processing system 1000. For instance, program code stored in a computer readable storage medium in a server data processing system may be downloaded over a network from the server to data processing system 1000. The data processing system providing program code 1018 may be a server computer, a client computer, or some other device capable of storing and transmitting program code 1018.

The different components illustrated for data processing system 1000 are not meant to provide architectural limitations to the manner in which different embodiments may be implemented. The different advantageous embodiments may be implemented in a data processing system including components in addition to or in place of those illustrated for data processing system 1000. Other components shown in FIG. 10 can be varied from the illustrative examples shown. The different embodiments may be implemented using any hardware device or system capable of running program code. As one example, the data processing system may include organic components integrated with inorganic components and/or may be comprised entirely of organic components excluding a human being. For example, a storage device may be comprised of an organic semiconductor.

In another illustrative example, processor unit 1004 may take the form of a hardware unit that has circuits that are manufactured or configured for a particular use. This type of hardware may perform operations without needing program code to be loaded into a memory from a storage device to be configured to perform the operations.

For example, when processor unit 1004 takes the form of a hardware unit, processor unit 1004 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, programmable array logic, a field programmable logic array, a field programmable gate array, and other suitable hardware devices. With this type of implementation, program code 1018 may be omitted, because the processes for the different embodiments are implemented in a hardware unit.

In still another illustrative example, processor unit 1004 may be implemented using a combination of processors found in computers and hardware units. Processor unit 1004 may have a number of hardware units and a number of processors that are configured to run program code 1018. With this depicted example, some of the processes may be implemented in the number of hardware units, while other processes may be implemented in the number of processors.

In another example, a bus system may be used to implement communications fabric 1002 and may be comprised of one or more buses, such as a system bus or an input/output bus. Of course, the bus system may be implemented using any suitable type of architecture that provides for a transfer of data between different components or devices attached to the bus system.

Additionally, communications unit 1010 may include a number of devices that transmit data, receive data, or transmit and receive data. Communications unit 1010 may be, for example, a modem or a network adapter, two network adapters, or some combination thereof.

Further, a memory may be, for example, memory 1006, or a cache, such as found in an interface and memory controller hub that may be present in communications fabric 1002.

The description of the different advantageous embodiments has been presented for purposes of illustration and description and is not intended to be exhaustive or to limit the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for validating software parts on an aircraft, comprising:
calculating a first hash value for a software part on the aircraft;
determining, on the aircraft, whether the first hash value matches a second hash value from a software integrity data structure stored on the aircraft, the software integrity data structure comprising hash values that are not determined on the aircraft for the software parts used by the aircraft; and
performing an operation on the software part on the aircraft only if the first hash value matches the second hash value.

2. The method of claim 1 further comprising:
calculating, on the aircraft, a number of first attributes for the software part;
determining, on the aircraft, whether the number of first attributes matches a number of second attributes in the software integrity data structure; and
performing the operation on the software part on the aircraft only if both the number of first attributes matches the number of second attributes and the first hash value matches the second hash value.

3. The method of claim 2, wherein the number of second attributes comprises a fingerprint for the software part.

4. The method of claim 1, wherein calculating the first hash value and determining whether the first hash value matches a second hash value are performed by an electronic system on the aircraft.

5. The method of claim 1, wherein:
calculating the first hash value comprises sending the software part to a software validator on the aircraft, receiving the software part by the software validator, and calculating the first hash value from the software part by the software validator;
determining whether the first hash value matches the second hash value comprises identifying a record for the software part in the software integrity data structure, retrieving the second hash value from the record, and comparing the first hash value to the second hash value by the software validator; and
further comprising sending an indication by the software validator if the first hash value matches the second hash value.

6. The method of claim 1, wherein:
calculating the first hash value comprises calculating the first hash value by an electronic system on the aircraft and sending the first hash value from the electronic system to a software validator on the aircraft;
determining whether the first hash value matches the second hash value comprises receiving the first hash value by the software validator, identifying a record for the software part in the software integrity data structure, retrieving the second hash value from the record, and comparing the first hash value to the second hash value by the software validator; and
further comprising sending an indication by the software validator to the electronic system if the first hash value matches the second hash value.

7. The method of claim 1, wherein the software integrity data structure comprises:
attributes describing the software integrity data structure; and
a number of records, each of the number of records corresponding to a software part used by the aircraft and comprising a hash value for a corresponding software part.

8. An apparatus comprising:
a software integrity data structure stored on an aircraft, the software integrity data structure comprising hash values that are not determined on the aircraft for software parts used by the aircraft;
a calculator on the aircraft configured to calculate a first hash value for a software part on the aircraft;
a comparator on the aircraft configured to determine whether the first hash value matches a second hash value from the software integrity data structure; and
wherein the aircraft is configured to perform an operation on the software part only if the first hash value matches the second hash value.

9. The apparatus of claim 8, wherein:
the calculator is configured to calculate a number of first attributes for the software part;
the comparator is configured to determine whether the number of first attributes matches a number of second attributes in the software integrity data structure; and
the aircraft is configured to perform the operation on the software part only if both the number of first attributes matches the number of second attributes and the first hash value matches the second hash value.

10. The apparatus of claim 9, wherein the number of second attributes comprises a fingerprint for the software part.

11. The apparatus of claim 8, wherein the calculator and the comparator are implemented on an electronic system on the aircraft, and the operation on the software part is performed by the electronic system on the aircraft.

12. The apparatus of claim 8, wherein:
the calculator is implemented in a software validator on the aircraft, the software validator is configured to receive the software part and determine the first hash value from the software part; and
the comparator is implemented in the software validator, the software validator further configured to identify a record for the software part in the software integrity data structure, retrieve the second hash value from the record, compare the first hash value to the second hash value, and send an indication if the first hash value matches the second hash value.

13. The apparatus of claim 8, wherein:
the calculator is implemented in an electronic system on the aircraft, the electronic system configured to send the first hash value to a software validator on the aircraft;
the comparator is implemented in the software validator, the software validator configured to receive the first hash value from the electronic system, identify a record for the software part in the software integrity data structure, retrieve the second hash value from the record, compare the first hash value to the second hash value, and send an indication to the electronic system if the first hash value matches the second hash value; and
electronic systems are further configured to perform the operation on the software part responsive to the indication from the software validator.

14. The apparatus of claim 8, wherein the software integrity data structure comprises:
attributes describing the software integrity data structure; and
a number of records, each of the number of records corresponding to a software part used by the aircraft and comprising a hash value for a corresponding software part.

15. A method for validating software parts for an aircraft comprising:
receiving a number of software parts;
determining a hash value for each of the number of software parts to form a number of hash values; and
combining the number of hash values into a software integrity data structure for use in determining whether to perform operations on the number of software parts on the aircraft.

16. The method of claim 15 further comprising:
loading the software integrity data structure onto the aircraft;
loading the number of software parts onto the aircraft; and
using the number of hash values from the software integrity data structure to validate the number of software parts on the aircraft before performing the operations on the number of software parts on the aircraft.

17. The method of claim 15 further comprising:
determining a fingerprint for the each of the number of software parts to form a number of fingerprints; and
combining the number of fingerprints into the software integrity data structure.

18. The method of claim 15, wherein the software integrity data structure comprises:
attributes describing the software integrity data structure; and
a number of records, each of the number of records corresponding to a software part used by the aircraft and comprising the hash value for a corresponding software part.

19. The method of claim 18, wherein the attributes comprise the attributes selected from a group of attributes consisting of a version identifier for the software integrity data structure, a version identifier for a schema used to create the software integrity data structure, information about aircraft applicability, a name of an entity that created the software integrity data structure, and a date that the software integrity data structure was created.

20. The method of claim 18, wherein the each of the number of records further comprise the attributes selected from a group of attributes consisting of a part number for the corresponding software part, a number indicating a number of files that make up the corresponding software part, and a fingerprint for the software part.
